(19) United States
(12) Patent Application Publication
(10) Pub. No.: US 2026/0014511 A1
(43) Pub. Date: Jan. 15, 2026

(54) SCRUBBING APPARATUS

(71) Applicant: Seung Hwan OH, Seoul (KR)

(72) Inventor: Seung Hwan OH, Seoul (KR)

(21) Appl. No.: 19/204,781

(22) Filed: May 12, 2025

Related U.S. Application Data
(63) Continuation of application No. PCT/KR2024/011941, filed on Aug. 12, 2024.

(30) Foreign Application Priority Data
Jul. 10, 2024 (KR) 10-2024-0090921

(51) Int. Cl. B01D 47/02; B01D 47/06

(52) U.S. Cl. CPC B01D 47/028; B01D 47/06

(57) ABSTRACT

The scrubbing apparatus of present invention comprises a scrubbing chamber a first scrubbing plate disposed in the scrubbing chamber, a plurality of first scrubbing holes penetrating the first scrubbing plate, a second scrubbing plate on the first scrubbing plate, a plurality of second scrubbing holes penetrating the second scrubbing plate, a first spray nozzle supplying a first scrubbing solution onto an upper surface of the first scrubbing plate, and a second spray nozzle supplying a second scrubbing solution onto an upper surface of the second scrubbing plate, wherein a portion of impurities contained in the gas is dissolved in the first scrubbing solution by ascending through the plurality of first scrubbing holes, and wherein another portion of the impurities contained in the gas is dissolved in the second scrubbing solution by ascending through the plurality of second scrubbing holes.

### TECHNICAL FIELD

The present invention relates to a scrubbing apparatus. Specifically, the present invention relates to a scrubbing apparatus that improves scrubbing efficiency by increasing the contact area between the scrubbing solution and the gas, and enhances stability by supplying the scrubbing solution in a spray form.

### BACKGROUND ART

In modern industries, various types of air pollutants are generated, many of which have extremely low permissible exposure limits for humans. Accordingly, removing air pollutants from gases emitted in various industrial fields before discharge is a critical issue.

Currently used air pollution prevention facilities include dust collectors and scrubbers, and they are installed considering their efficiency depending on the type of pollutant. Among these, scrubbers are widely used because they can simultaneously process dust, exhaust gas, and high-temperature gas.

Specifically, scrubbers are classified into dry, wet, and plasma types depending on the method of treating the exhaust gas, and wet scrubbers are used in a process that causes the exhaust gas to come into contact with a liquid to dissolve water-soluble components in the gas into the liquid.

In wet scrubbers, a cleaning solution is generally used to effectively remove harmful components of the exhaust gas. When the cleaning solution comes into contact with harmful components, it removes the harmful components through a chemical reaction such as neutralization, so the one that best reacts chemically with the harmful components of the emitted gas should be selected. The performance of the wet scrubber is determined by whether the solution containing the cleaning solution can efficiently contact the exhaust gas. Accordingly, in the related art, a filler is installed to ensure sufficient contact between the cleaning solution and the discharged gas, and a spray nozzle is employed to supply a cleaning solution having fine particles.

Recently, a technology that can improve the contact area between the scrubbing solution containing the cleaning solution and the exhaust gas has been studied.

### SUMMARY

### Technical Problem

The technical problem to be solved by the present invention is to provide a scrubbing apparatus that improves scrubbing efficiency by increasing the contact area between the scrubbing solution and the gas, and enhances stability by supplying the scrubbing solution in a spray form.

The problems that the present invention is trying to solve are not limited to the problems mentioned above, and other problems that are not mentioned can be clearly understood by those skilled in the art from the description below.

### Solution to Problem

A scrubbing apparatus according to some embodiments of the present invention for achieving the above technical problem comprises a scrubbing chamber defining a scrubbing space for scrubbing impurities contained in a gas, a first scrubbing plate disposed in the scrubbing chamber, a plurality of first scrubbing holes penetrating the first scrubbing plate, a second scrubbing plate on the first scrubbing plate, and disposed in the scrubbing chamber, a plurality of second scrubbing holes penetrating the second scrubbing plate, a first spray nozzle supplying a first scrubbing solution onto an upper surface of the first scrubbing plate, wherein the first spray nozzle is disposed between the first scrubbing plate and the second scrubbing plate, and a second spray nozzle supplying a second scrubbing solution onto an upper surface of the second scrubbing plate, wherein the second spray nozzle is disposed on the second scrubbing plate, wherein a portion of impurities contained in the gas is dissolved in the first scrubbing solution by ascending through the plurality of first scrubbing holes, and wherein another portion of the impurities contained in the gas is dissolved in the second scrubbing solution by ascending through the plurality of second scrubbing holes.

Since spray nozzles are disposed on the upper surfaces of the first scrubbing plate and the second scrubbing plate, the heights of the bubbles formed on the respective upper surfaces of the scrubbing plates may be controlled.

In some embodiments, wherein a diameter of each of the plurality of first scrubbing holes is greater than a diameter of each of the plurality of second scrubbing holes. Since the amount of scrubbing solution discharged onto the upper surface of the first scrubbing plate is greater than the amount discharged onto the upper surface of the second scrubbing plate, the diameter of the first scrubbing hole is greater than the diameter of the second scrubbing hole.

In some embodiments, wherein, in a planar view, an area of the plurality of first scrubbing holes relative to an area of the first scrubbing plate is greater than an area of the plurality of second scrubbing holes relative to an area of the second scrubbing plate.

In some embodiments, wherein a diameter of each of the plurality of first scrubbing holes is equal to a diameter of each of the plurality of second scrubbing holes.

In some embodiments, wherein the number of the plurality of first scrubbing holes is greater than the number of the plurality of second scrubbing holes.

The scrubbing apparatus according to some embodiments further comprises a scrubbing solution storage tank disposed at a lower part of the scrubbing chamber, the scrubbing solution storage tank storing a scrubbing solution in which the impurities are dissolved, and a first recycle pipe having one end connected to the scrubbing solution storage tank and the other end connected to the first spray nozzle, wherein the first spray nozzle supplies the scrubbing solution, in which the impurities are dissolved, and which is stored in the scrubbing solution storage tank, onto the upper surface of the first scrubbing plate through the first recycle pipe.

According to some embodiments, by recycling the scrubbing solution in which impurities are dissolved, the amount of scrubbing solution used may be reduced.

In some embodiments, wherein the second scrubbing solution is water that does not contain the impurities.

The scrubbing apparatus according to some embodiments further comprises a second recycle pipe having one end connected to the scrubbing solution storage tank and the other end connected to the second spray nozzle, wherein the second spray nozzle supplies the scrubbing solution, in which the impurities are dissolved, and which is stored in the scrubbing solution storage tank, onto the upper surface of the second scrubbing plate through the second recycle pipe.

According to some embodiments, by recycling the scrubbing solution in which impurities are dissolved, the amount of scrubbing solution used may be reduced.

The scrubbing apparatus according to some embodiments further comprises a third scrubbing plate disposed on the second scrubbing plate, and disposed in the scrubbing chamber, a plurality of third scrubbing holes penetrating the third scrubbing plate, and a third spray nozzle supplying a third scrubbing solution onto an upper surface of the third scrubbing plate, wherein the third spray nozzle is disposed on the third scrubbing plate, wherein the third spray nozzle supplies the third scrubbing solution in a spray form, and wherein another portion of the impurities contained in the gas is dissolved in the third scrubbing solution by ascending through the plurality of third scrubbing holes.

In some embodiments, wherein a diameter of each of the plurality of second scrubbing holes is greater than a diameter of each of the plurality of third scrubbing holes, and wherein a diameter of each of the plurality of first scrubbing holes is greater than the diameter of each of the plurality of second scrubbing holes.

In some embodiments, wherein a diameter of each of the plurality of second scrubbing holes is greater than a diameter of each of the plurality of third scrubbing holes, and wherein a diameter of each of the plurality of first scrubbing holes is smaller than the diameter of each of the plurality of second scrubbing holes.

In some embodiments, wherein a concentration of the impurities in the third scrubbing solution is lower than a concentration of the impurities in the second scrubbing solution.

In some embodiments, wherein the first scrubbing solution is the same as the second scrubbing solution.

The scrubbing apparatus according to some embodiments further comprises a second scrubbing wall disposed at one end of the second scrubbing plate and partially protruding from an upper surface of the second scrubbing plate, wherein the second scrubbing solution discharged onto the upper surface of the second scrubbing plate flows over the second scrubbing wall and is discharged onto the upper surface of the first scrubbing plate, and wherein another portion of the impurities contained in the gas is dissolved in the second scrubbing solution that has flowed over the second scrubbing wall by ascending through the first scrubbing holes.

In some embodiments, wherein the first spray nozzle supplies the first scrubbing solution in a spray form onto the upper surface of the first scrubbing plate, and wherein the second spray nozzle supplies the second scrubbing solution in a spray form onto the upper surface of the second scrubbing plate.

Specific details of other embodiments are included in the specification and drawings.

### Effect of Invention

The scrubbing apparatus of the present invention includes at least one scrubbing plate. Scrubbing holes penetrating the scrubbing plate are formed in the scrubbing plate. As the gas ascends through the scrubbing holes, bubbles may be formed within the scrubbing solution flowing on an upper surface of the scrubbing plate.

As the bubbles are formed, the contact area between the scrubbing solution and the gas increases. Due to the increased contact area, hydrophilic impurities in the gas may be dissolved more effectively in the scrubbing solution. Accordingly, the gas from which impurities (contaminants) have been removed may be discharged to the outside of the scrubbing apparatus.

In addition, spray nozzles that discharge the scrubbing solution in a spray form are disposed above the upper surface of each scrubbing plate. As the scrubbing solution having fine particles is supplied onto the upper surface of each scrubbing plate, the height of the bubbles formed on the upper surface of each scrubbing plate may be controlled.

### BRIEF DESCRIPTION OF DRAWINGS

FIG. 1 is a drawing briefly explaining a scrubbing system including a scrubbing apparatus to some embodiments of the present invention.

FIG. 2 is an exemplary perspective view for explaining the scrubbing apparatus of FIG. 1.

FIG. 3 is an exemplary cross-sectional view for explaining the scrubbing apparatus of FIG. 1.

FIG. 4 is an enlarged view of the P1 area, P2 area, and P3 area of FIG. 3.

FIGS. 5, 6, 7, 8, 9 and 10 are drawings for explaining the scrubbing apparatus according to some other embodiments of the present invention, respectively.

FIGS. 11 and 12 are drawings for explaining an operating method of a scrubbing apparatus according to some embodiments of the present invention.

### DETAILED DESCRIPTION OF EXEMPLARY EMBODIMENTS

Hereinafter, preferred embodiments of the present invention will be described in detail with reference to the accompanying drawings. The advantages and features of the present invention and the methods for achieving them will become apparent with reference to the embodiments described in detail below together with the accompanying drawings. However, the present invention is not limited to the embodiments described below, but may be implemented in various different forms, and these embodiments are provided only to make the invention of the present invention complete and to fully inform those skilled in the art of the scope of the invention, and the present invention is defined only by the scope of the claims. Like reference numerals refer to like elements throughout the specification.

In addition, the terminology used herein is for the purpose of describing embodiments, and is not intended to limit and/or restrict the disclosed invention. The singular expression includes the plural expression unless the context clearly indicates otherwise. In this specification, the terms “comprises”, “include”, or “has” and the like are intended to specify that a feature, number, step, operation, component, part, or combination thereof described in the specification is present, but do not exclude in advance the possibility of the presence or addition of one or more other features, numbers, steps, operations, components, parts, or combinations thereof.

In addition, terms including ordinal numbers such as “first”, “second”, etc. used in this specification may be used to describe various components, but the components are not limited by the terms, and the terms are used only for the purpose of distinguishing one component from another. For example, without departing from the scope of the present invention, the first component may be named the second component, and similarly, the second component may also be named the first component. The term “and/or” includes a combination of multiple related described items or any item among multiple related described items.

Meanwhile, the terms “front”, “rear”, “upper”, “lower”, “front”, and “lower” used in the following description are defined based on the drawings, and the shape and position of each component are not limited by these terms.

The terms used in this specification are for describing embodiments and are not intended to limit the present invention. In this specification, the singular includes the plural unless specifically stated in the phrase. The terms “comprise” and/or “comprising” used in the specification do not exclude the presence or addition of one or more other components, steps, operations, and/or elements mentioned.

Unless otherwise defined, all terms (including technical and scientific terms) used in this specification may be used in a meaning that can be commonly understood by a person of ordinary skill in the art to which the present invention belongs. In addition, terms defined in commonly used dictionaries shall not be ideally or excessively interpreted unless explicitly specifically defined.

Hereinafter, embodiments of the present invention will be described in detail with reference to the attached drawings, and when describing with reference to the attached drawings, identical or corresponding components will be given the same reference numerals regardless of the drawing numbers, and redundant descriptions thereof will be omitted.

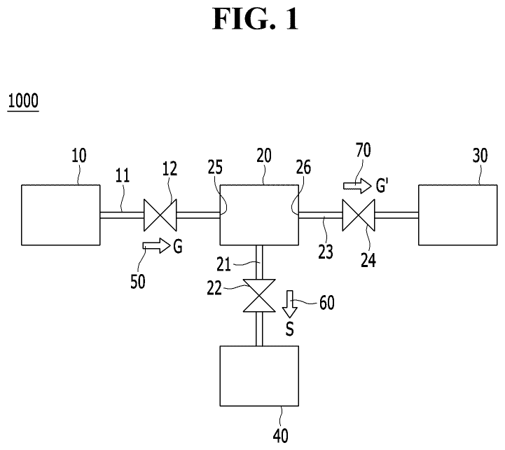

Hereinafter, first, a scrubbing system 1000 including a scrubbing apparatus 20 according to some embodiments of the present invention will be described with reference to FIG. 1. FIG. 1 is a drawing briefly explaining the scrubbing system including the scrubbing apparatus according to some embodiments of the present invention.

Referring to FIG. 1, the scrubbing system 1000 according to some embodiments of the present invention may include a process chamber 10, a scrubbing apparatus 20, an exhaust gas discharge chamber 30, and a scrubbing solution discharge chamber 40.

The process chamber 10 may be a chamber utilized in various industrial fields. The various industrial fields may be a plant field, a battery field, a thermal power plant field, a steel field, a semiconductor field, a chemical field, and/or an oil and gas plant field.

If the scrubbing system 1000 is utilized in the semiconductor field, the process chamber 10 may be a chamber in which a semiconductor process is performed. In order to manufacture a semiconductor device, various semiconductor processes must be performed on a wafer. For example, a film must be deposited on the wafer (deposition process), and the film must be etched (etching process) to form a pattern included in the semiconductor device. In addition, after the deposition process and/or the etching process are performed, a cleaning process must be performed to clean the wafer and/or the process chamber 10.

The deposition process may include, for example, physical vapor deposition (PVD), chemical vapor deposition (CVD), and/or atomic layer deposition (ALD). The etching process may include, for example, a dry etching process, a wet etching process, and/or an ashing process. The cleaning process may include, for example, a wet cleaning process, a dry cleaning process, and/or a vapor cleaning process.

If the scrubbing system 1000 is utilized in the oil and gas plant industry, the process chamber 10 may be a chamber where the plant process is performed.

When various processes are performed in the process chamber 10, various byproducts may be generated. The byproducts may include substances harmful to the human body, and if the byproducts include substances harmful to the human body, they must be removed and discharged. The scrubbing apparatus 20 may be used to remove substances harmful to the human body and the byproducts generated in the process chamber 10.

A first pipe 11 may be disposed between the process chamber 10 and the scrubbing apparatus 20. One end of the first pipe 11 may be connected to the process chamber 10, and the other end of the first pipe 11 may be connected to the scrubbing apparatus 20. A gas G discharged from the process chamber 10 may be provided to the scrubbing apparatus 20 through the first pipe 11 (see reference numeral 50). The gas G may contain impurities. The impurities may be substances harmful to the human body. The impurities may contain hydrophilic substances.

In some embodiments, a first valve 12 may be connected to the first pipe 11. The first valve 12 may control the pressure and flow rate of the gas G provided to the scrubbing apparatus 20 through the first pipe 11.

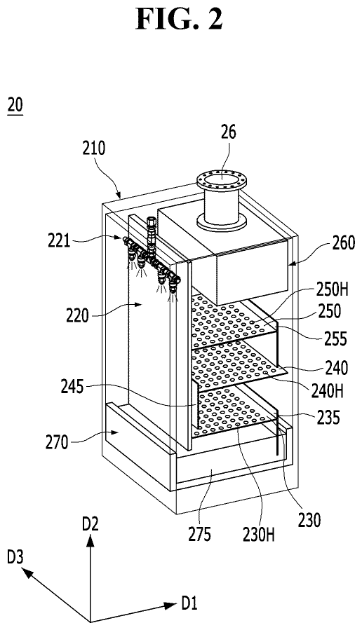

The scrubbing apparatus 20 may scrub the gas G provided from the process chamber 10. The impurities contained in the gas G may be dissolved in a scrubbing solution and stored in the scrubbing solution discharge chamber 40. The gas G′ from which the impurities have been removed may be stored in the exhaust gas discharge chamber 30. A detailed description of the scrubbing apparatus 20 will be described later using FIGS. 2 to 10.

The scrubbing solution discharge chamber 40 may be connected to the scrubbing apparatus 20. The scrubbing solution discharge chamber 40 and the scrubbing apparatus 20 may be connected to each other through a second pipe 21. One end of the second pipe 21 may be connected to the scrubbing apparatus 20, and the other end of the second pipe 21 may be connected the scrubbing solution discharge chamber 40. Through the second pipe 21, the scrubbing solution S in which impurities are dissolved may move from the scrubbing apparatus 20 to the scrubbing solution discharge chamber 40 (see reference numeral 60).

In some embodiments, a second valve 22 may be connected to the second pipe 21. The second valve 22 may control the pressure and flow rate of the scrubbing solution S containing dissolved impurities, which is supplied to the scrubbing solution discharge chamber 40 through the second pipe 21.

The exhaust gas discharge chamber 30 may be connected to the scrubbing apparatus 20. The exhaust gas discharge chamber 30 and the scrubbing apparatus 20 may be connected to each other through a third pipe 23. One end of the third pipe 23 may be connected to the scrubbing apparatus 20, and the other end of the third pipe 23 may be connected to the exhaust gas discharge chamber 30. Through the third pipe 23, the gas G′ from which impurities have been removed may move from the scrubbing apparatus 20 to the exhaust gas discharge chamber 30 (see reference numeral 70).

In some embodiments, a third valve 24 may be connected to the third pipe 23. The third valve 24 may control the pressure and flow rate of the gas G′ from which impurities have been removed and provided to the exhaust gas discharge chamber 30 through the third pipe 23.

In some embodiments, the scrubbing apparatus 20 may further include a gas inlet port 25 and a gas outlet port 26. The gas G may be introduced into the scrubbing apparatus 20 through the gas inlet port 25. The gas G′ from which impurities have been removed may be discharged to the exterior of the scrubbing apparatus 20 through the gas outlet port 26.

When the scrubbing apparatus 20 according to some embodiments of the present invention is utilized in the industrial field, pollutants generated after the process may be effectively separated and removed. Accordingly, environmental pollution problems may be reduced.

Hereinafter, a scrubbing apparatus according to some embodiments of the present invention will be described in detail with reference to FIGS. 2 to 4.

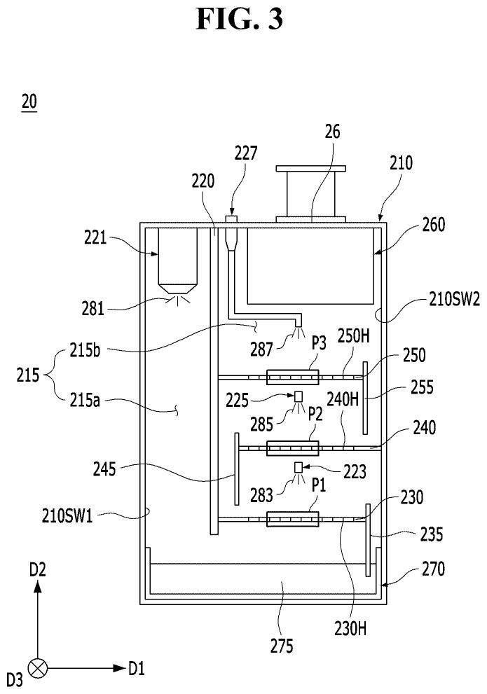

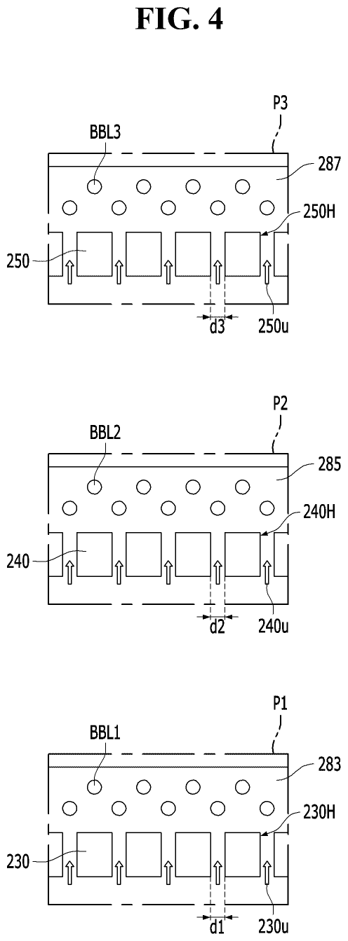

FIG. 2 is an exemplary perspective view for explaining the scrubbing apparatus of FIG. 1. FIG. 3 is an exemplary cross-sectional view for explaining the scrubbing apparatus of FIG. 1. FIG. 4 is an enlarged view of the P1 area, P2 area, and P3 area of FIG. 3.

Referring to FIGS. 2 to 4, the scrubbing apparatus 20 according to some embodiments of the present invention may comprise a scrubbing chamber 210, a separating wall 220, a first scrubbing plate 230, a second scrubbing plate 240, a third scrubbing plate 250, a first spray nozzle 223, a second spray nozzle 225, a third spray nozzle 227, a fourth spray nozzle 221, and a demister 260.

First, the scrubbing chamber 210 may be provided. The scrubbing chamber 210 may be an outer housing of the scrubbing apparatus 20. A gas (G of FIG. 1) may be provided in the scrubbing chamber 210. The gas may contain impurities. For example, the gas (G of FIG. 1) may be provided into an interior of the scrubbing chamber 210 through the gas inlet port (25 of FIG. 1). The gas inlet port may be formed on an upper wall of the scrubbing chamber 210 or a side wall of the scrubbing chamber 210. Also, the gas inlet port may be formed on an upper part of the side wall of the scrubbing chamber 210 or a lower part of the side wall of the scrubbing chamber 210.

The impurities contained in the gas (G of FIG. 1) inside the scrubbing chamber 210 may be dissolved in the scrubbing solution. The scrubbing chamber 210 may define a scrubbing space 215. The scrubbing space 215 may be a space where a scrubbing process is performed in which impurities contained in the gas (G of FIG. 1) are dissolved in the scrubbing solution.

In some embodiments, the scrubbing space 215 may be include a first sub-space 215a and a second sub-space 215b. The first sub-space 215a and the second sub-space 215b may be divided by the separating wall 220. The first sub-space 215a and the second sub-space 215b may be defined by the separating wall 220.

The separating wall 220 may be disposed in the scrubbing chamber 210. In some embodiments, the separating wall 220 may be attached to the upper wall of the scrubbing chamber 210. The separating wall 220 may extend from the upper wall of the scrubbing chamber 210 in a second direction D2. The second direction D2 may be a direction perpendicular to the ground.

In some embodiments, the separating wall 220 may have a bar shape in a planar view. The separating wall 220 may extend in a third direction D3 in a planar view. One end of the separating wall 220 may be connected to and in contact with a third inner side wall of the scrubbing chamber 210, and the other end of the separating wall 220 may be connected to and in contact with a fourth inner side wall of the scrubbing chamber 210. The separating wall 220 may include a long side extending in the third direction D3 and a short side extending in a first direction D1, but technical scope of the present invention is not limited thereto.

In some embodiments, the scrubbing chamber 210 may include a first inner side wall 210SW1, a second inner side wall 210SI2, the third inner side wall, and the fourth inner side wall.

The first inner side wall 210SW1 of the scrubbing chamber 210 may face the separating wall 220. The second inner side wall 210SW2 of the scrubbing chamber 210 may face the first inner side wall 210SW1 in the first direction D1. The third inner side wall and the fourth inner side wall may face each other in the third direction D3 and may intersect the first inner side wall 210SW1 and the second inner side wall 210SW, respectively.

The separating wall 220 may define the first sub-space 215a and the second sub-space 215b. The separating wall 220 may divide the scrubber space 215 into the first sub-space 215a and the second sub-space 215b.

A first scrubbing process may be performed in the first sub-space 215a. A second scrubbing process may be performed in the second sub-space 215b. The first scrubbing process may be a process in which a portion of the impurities is dissolved in the fourth scrubbing solution 281. The second scrubbing process may be a process in which another portion of the impurities is dissolved in first to third scrubbing solution 283, 285, and 287.

In this specification, the first direction D1 and the third direction D3 may intersect each other. The first direction D1 and the second direction D2 may intersect each other. The second direction D2 and the third direction D3 may intersect each other. That is, in this specification, the first direction D1, the second direction D2, and the third direction D3 may be substantially perpendicular to each other.

The first scrubbing plate 230, the second scrubbing plate 240, and the third scrubbing plate 250 may be disposed in the scrubbing space 215. Specifically, the first scrubbing plate 230, the second scrubbing plate 240, and the third scrubbing plate 250 may be disposed in the second sub-space 215b.

In FIGS. 2 to 4, the scrubbing apparatus 20 of the present invention is illustrated as including three scrubbing plates, but the technical scope of the present invention is not limited thereto. The scrubbing apparatus 20 according to some embodiments of the present invention may include at least one scrubbing plate. That is, one or two scrubbing plates may be arranged inside the second sub-space 215b, or four or more may be arranged.

If four or more scrubbing plates are disposed within the second sub-space 215b, spray nozzles may be provided on each of the scrubbing plates. Accordingly, the scrubbing solution may be discharged in a spray form onto the upper surface of each scrubbing plate. However, the technical scope of the present invention is not limited thereto.

The first scrubbing plate 230 may be arranged at the lowest position among the scrubbing plates arranged inside the second sub-space 215b. One end of the first scrubbing plate 230 may be connected to and fixed to the separating wall 220. Specifically, one end of the first scrubbing plate 230 may be connected to and fixed to a side wall of the separating wall 220 facing the second sub-space 215b. The first scrubbing plate 230 may be connected to the separating wall 220 and may extend in the first direction D1 intersecting the separating wall 220. More specifically, the first scrubbing plate 230 may be disposed on a plane on which the first direction D1 and the third direction D3 extend.

In some embodiments, another portion of the first scrubbing plate 230 may be connected and fixed to the inner side walls of the scrubbing chamber 210. Specifically, the first scrubbing plate 230 may be connected to the separating wall 220, the third inner side wall of the scrubbing chamber 210, and the fourth inner side wall of the scrubbing chamber 210 within the second sub-space 215b.

However, the first scrubbing plate 230 may not be fixedly connected to the second inner side wall 210SW2 of the scrubbing chamber 210. The first scrubbing plate 230 may be spaced apart from the second inner side wall 210SW2 of the scrubbing chamber 210 in the first direction D1. The space between the other end of the first scrubbing plate 230 and the second inner side wall 210SW2 of the scrubbing chamber 210 may serve as a flow path in which the first scrubbing solution 283, or the first to third scrubbing solutions 283, 285, and 287, flow downward (e.g., in the second direction D2).

In some embodiments, the first spray nozzle 223 may be disposed on the first scrubbing plate 230. The first spray nozzle 223 may be provided between the first scrubbing plate 230 and the second scrubbing plate 240. The first spray nozzle 223 may supply the first scrubbing solution 283 onto the upper surface of the first scrubbing plate 230. Specifically, the first spray nozzle 223 may supply the first scrubbing solution 283 to a central portion of the upper surface of the first scrubbing plate 230. The first spray nozzle 223 may supply the first scrubbing solution 283 having fine particles. As the first scrubbing solution 283 having fine particles is provided, a height of first bubbles BBL1 formed on the upper surface of the first scrubbing plate 230 may be controlled.

The scrubbing apparatus 20 according to some embodiments may further include a first scrubbing hole 230H and a first scrubbing wall 235.

The first scrubbing hole 230H may be formed inside the first scrubbing plate 230. The first scrubbing hole 230H may extend from the lower surface of the first scrubbing plate 230 to the upper surface of the first scrubbing plate 230. That is, the first scrubbing hole 230H may penetrate the first scrubbing plate 230 in the second direction D2. The gas (G of FIG. 1) may ascend in the second direction D2 by passing through the first scrubbing hole 230H (see reference numeral 230u).

The upper surface of the first scrubbing plate 230 may face the demister 260 to be described later, and the lower surface of the first scrubbing plate 230 may face the scrubbing solution storage tank 270 to be described later.

The first scrubbing wall 235 may be attached to the other end of the first scrubbing plate 230. The first scrubbing wall 235 may be interposed between the first scrubbing plate 230 and the second inner side wall 210SW2 of the scrubbing chamber 210. The first scrubbing wall 235 may extend in the second direction D2. In some embodiments, a portion of the first scrubbing wall 235 may protrude from the upper surface of the first scrubbing plate 230 in the second direction D2. Another portion of the first scrubbing wall 235 may protrude from the lower surface of the first scrubbing plate 230 in the second direction D2.

The length in the second direction D2 of the portion of the first scrubbing wall 235 protruding from the upper surface of the first scrubbing plate 230 may be less than the length in the second direction D2 of the portion protruding from the lower surface of the first scrubbing plate 230, but the technical scope of the present invention is not limited thereto.

In some embodiments, at least a portion of the first scrubbing plate 230 protruding from the lower surface of the first scrubbing wall 235 in the second direction D2 may be placed in the scrubbing solution 275 in which impurities are dissolved, but the technical scope of the present invention is not limited thereto.

The second scrubbing plate 240 may be disposed on the first scrubbing plate 230. Specifically, the second scrubbing plate 240 may be disposed on the upper surface of the first scrubbing plate 230. One end of the second scrubbing plate 240 may be connected to and fixed to the second inner side wall 210SW2 of the scrubbing chamber 210. The second scrubbing plate 240 may be connected to the second inner side wall 210SW2 of the scrubbing chamber 210 and may extend in the first direction D1 intersecting the second inner side wall 210SW2 of the scrubbing chamber 210. More specifically, the second scrubbing plate 240 may be placed on a plane on which the first direction D1 and the third direction D3 extend.

Similarly, the second scrubbing plate 240 may be connected to and fixed to the third inner side wall of the scrubbing chamber 210 and the fourth inner side wall of the scrubbing chamber 210. However, the other end of the second scrubbing plate 240 may not be fixedly connected to the separating wall 220. The other end of the second scrubbing plate 240 may be spaced apart from the side wall of the separating wall 220 in the first direction D1. The space between the other end of the second scrubbing plate 240 and the separating wall 220 may serve as a flow path in which the second scrubbing solution 285, or the third scrubbing solutions 287, flow downward (e.g., in the second direction D2).

In some embodiments, the second spray nozzle 225 may be disposed on the second scrubbing plate 240. The second spray nozzle 225 may be provided between the second scrubbing plate 240 and the third scrubbing plate 250. The second spray nozzle 225 may supply the second scrubbing solution 285 onto an upper surface of the second scrubbing plate 240. Specifically, the second spray nozzle 225 may supply the second scrubbing solution 285 to a central portion of the upper surface of the second scrubbing plate 240. The second spray nozzle 225 may supply the second scrubbing solution 285 having fine particles. As the second scrubbing solution 285 having fine particles is provided, a height of second bubbles BBL2 formed on the upper surface of the second scrubbing plate 240 may be controlled.

In some embodiments, the scrubbing apparatus 20 according to some embodiments may further include a second scrubbing hole 240H and a second scrubbing wall 245.

The second scrubbing hole 240H may be formed inside the second scrubbing plate 240. The second scrubbing hole 240H may extend from the lower surface of the second scrubbing plate 240 to the upper surface of the second scrubbing plate 240. The second scrubbing hole 240H may penetrate the second scrubbing plate 240 in the second direction D2. The gas (G of FIG. 1) may ascend in the second direction D2 by passing through the second scrubbing hole 240H (see reference numeral 240u).

The upper surface of the second scrubbing plate 240 may face the demister 260 to be described later, and the lower surface of the second scrubbing plate 240 may face the upper surface of the first scrubbing plate 230.

The second scrubbing wall 245 may be attached to the other end of the second scrubbing plate 240. The second scrubbing wall 245 may be interposed between the second scrubbing plate 240 and the separating wall 220. The second scrubbing wall 245 may extend in the second direction D2. In some embodiments, a portion of the second scrubbing wall 245 may protrude from the upper surface of the second scrubbing plate 240 in the second direction D2. Another portion of the second scrubbing wall 245 may protrude from the lower surface of the second scrubbing plate 240 in the second direction D2.

A length in the second direction D2 of the portion protruding in the second direction D2 from the upper surface of the second scrubbing plate 240 among the second scrubbing wall 245 may be less than a length in the second direction D2 of the portion protruding in the second direction D2 from the lower surface of the second scrubbing plate 240, but the technical scope of the present invention is not limited thereto.

In some embodiments, the first scrubbing plate 230 and the second scrubbing plate 240 do not completely overlap in the second direction D2. The first scrubbing plate 230 and the second scrubbing plate 240 may be arranged in a zigzag configuration. Accordingly, the second scrubbing solution 285 that flows downward over the second scrubbing wall 245 may be discharged onto the upper surface of the first scrubbing plate 230. In other words, a center of the first scrubbing plate 230 and a center of the second scrubbing plate 240 may be offset from each other.

The third scrubbing plate 250 may be disposed on the second scrubbing plate 240. Specifically, the third scrubbing plate 250 may be disposed on the upper surface of the second scrubbing plate 240. One end of the third scrubbing plate 250 may be connected to and fixed to the separating wall 220.

Specifically, one end of the third scrubbing plate 250 may be connected and fixed to the side wall of the separating wall 220 facing the second sub-space 215b. The third scrubbing plate 250 may be connected to the separating wall 220 and may extend in a first direction D1 intersecting the separating wall 220. More specifically, the third scrubbing plate 250 may be placed on a plane along which the first direction D1 and the third direction D3 extend. Similarly, the third scrubbing plate 250 may be connected and fixed to the third inner side wall of the scrubbing chamber 210 and the fourth inner side wall of the scrubbing chamber 210.

However, the other end of the third scrubbing plate 250 may not be connected to and fixed to the second inner side wall 210SW2 of the scrubbing chamber 210. The other end of the third scrubbing plate 250 may be spaced apart from the second inner side wall 210SW2 of the scrubbing chamber 210 in the first direction D1. The space between the other end of the third scrubbing plate 250 and the second inner side wall 210SW2 of the scrubbing chamber 210 may serve a flow path in which the third scrubbing solution 287, which will be described later, flows downward (for example, in the second direction D2).

In some embodiments, the third spray nozzle 227 may be disposed on the third scrubbing plate 250. The third spray nozzle 227 may supply the third scrubbing solution 287 onto the upper surface of the third scrubbing plate 250. Specifically, the third spray nozzle 227 may supply the third scrubbing solution 287 to a central portion of the upper surface of the third scrubbing plate 250. The third spray nozzle 227 may supply the third scrubbing solution 287 having fine particles. As the third scrubbing solution 287 having fine particles is provided, a height of third bubbles BBL3 formed on the upper surface of the third scrubbing plate 250 may be controlled.

The scrubbing apparatus 20 according to some embodiments may further include a third scrubbing hole 250H and a third scrubbing wall 255.

The third scrubbing hole 250H may be formed inside the third scrubbing plate 250. The third scrubbing hole 250H may extend from the lower surface of the third scrubbing plate 250 to the upper surface of the third scrubbing plate 250. The third scrubbing hole 250H may penetrate the third scrubbing plate 250 in the second direction D2. The gas (G of FIG. 1) may ascend in the second direction D2 by passing through the third scrubbing hole 250H (see reference numeral 250u).

The upper surface of the third scrubbing plate 250 may face the demister 260 to be described later, and the lower surface of the third scrubbing plate 250 may face the upper surface of the second scrubbing plate 240.

The third scrubbing wall 255 may be attached to the other end of the third scrubbing plate 250. The third scrubbing wall 255 may be interposed between the third scrubbing plate 250 and the second inner side wall 210SW2 of the scrubbing chamber 210. The third scrubbing wall 255 may extend in the second direction D2.

In some embodiments, a portion of the third scrubbing wall 255 may protrude in the second direction D2 from the upper surface of the third scrubbing plate 250. Another portion of the third scrubbing wall 255 may protrude in the second direction D2 from the lower surface of the third scrubbing plate 250.

A length in the second direction D2 of the portion protruding in the second direction D2 from the upper surface of the third scrubbing plate 250 among the third scrubbing wall 255 may be less than a length in the second direction D2 of the portion protruding in the second direction D2 from the lower surface of the third scrubbing plate 250, but the technical scope of the present invention is not limited thereto.

In some embodiments, the third scrubbing plate 250 and the second scrubbing plate 240 do not completely overlap in the second direction D2. The third scrubbing plate 250 and the second scrubbing plate 240 may be arranged in a zigzag configuration. The third scrubbing solution 287 that flows downward over the third scrubbing wall 255 may be discharged onto the upper surface of the second scrubbing plate 240. In other words, a center of the third scrubbing plate 250 and the center of the second scrubbing plate 240 may be offset from each other.

However, the third scrubbing plate 250 and the first scrubbing plate 230 may completely overlap in the second direction D2. That is, the center of the third scrubbing plate 250 and the center of the first scrubbing plate 230 may overlap in the second direction D2.

In some embodiments, the first to third scrubbing holes 230H, 240H, and 250H may completely overlap in the second direction D2. However, the technical scope of the present invention is not limited thereto. The first to third scrubbing holes 230H, 240H, and 250H may not completely overlap in the second direction D2, and may only partially overlap.

In some embodiments, the first to third scrubbing solutions 283, 285, and 287 may be water. The first to third scrubbing solutions 283, 285, and 287 may be the same. The concentrations of impurities contained in the first to third scrubbing solutions 283, 285, and 287 may also be the same. For example, the first to third scrubbing solutions 283, 285, and 287 may be pure water that does not contain any impurities. However, the technical scope of the present invention is not limited thereto.

After being discharged onto the upper surface of the third scrubbing plate 250, the third scrubbing solution 287 may flow toward the third scrubbing wall 255 on the upper surface of the third scrubbing plate 250 while the second scrubbing process is performed. In this case, the third scrubbing solution 287 does not flow downward through the third scrubbing holes 250H. The third scrubbing solution 287 may flow beyond the third scrubbing wall 255 and downward to the lower part of the scrubbing chamber 210.

Since the third scrubbing solution 287 is provided in a spray form, a height of the third bubbles BBL3 formed on the upper surface of the third scrubbing plate 250 may be controlled. Specifically, when the third bubbles BBL3 are formed with excessive height, the discharge amount of the third scrubbing solution 287 may be increased to reduce the height of the third bubbles BBL3.

The third scrubbing solution 287 that has flowed over the third scrubbing wall 255 may be discharged again onto the upper surface of the second scrubbing plate 240. While the second scrubbing process is performed, the third scrubbing solution 287 may flow toward the second scrubbing wall 245 on the upper surface of the second scrubbing plate 240.

In this case, the second spray nozzle 225 may supply the second scrubbing solution 285 onto the upper surface of the second scrubbing plate 240. By supplying the second scrubbing solution 285, a height of the second bubbles BBL2 formed on the second scrubbing plate 240 may be controlled. Specifically, when the second bubbles BBL2 are formed with excessive height, the second scrubbing solution 285 may be discharged to reduce the height of the second bubbles BBL2. In particular, the discharge amount of the second scrubbing solution 285 may be increased to reduce the height of the second bubbles BBL2 when the bubbles are formed excessively high.

The third scrubbing solution 287 and the second scrubbing solution 285 disposed on the upper surface of the second scrubbing plate 240 do not flow downward through the second scrubbing holes 240H. The third scrubbing solution 287 and the second scrubbing solution 285 may flow beyond the second scrubbing wall 245 and downward to the lower part of the scrubbing chamber 210.

Likewise, the third scrubbing solution 287 and the second scrubbing solution 285 that have flowed beyond the second scrubbing wall 245 may be discharged again onto the upper surface of the first scrubbing plate 230. While the second scrubbing process is performed, the third scrubbing solution 287 and the second scrubbing solution 285 may flow toward the first scrubbing wall 235 on the upper surface of the first scrubbing plate 230.

In this case, the first spray nozzle 223 may supply the first scrubbing solution 283 onto the upper surface of the first scrubbing plate 230. By supplying the first scrubbing solution 283, a height of the first bubbles BBL1 formed on the first scrubbing plate 230 may be controlled. Specifically, when the first bubbles BBL1 are formed with excessive height, the discharge amount of the first scrubbing solution 283 may be increased to reduce the height of the first bubbles BBL1.

In this case, the first to third scrubbing solutions 283, 285, and 287 do not flow downward through the first scrubbing holes 230H. The first to third scrubbing solutions 283, 285, and 287 may flow beyond the first scrubbing wall 235 and downward to the lower part of the scrubbing chamber 210.

Finally, the first to third scrubbing solutions 283, 285, and 287 that have flowed over the first scrubbing wall 235 may be stored in the scrubbing solution storage tank 270 provided at the lower part of the scrubbing chamber 210. The scrubbing solution 275 in which impurities are dissolved may be stored in the scrubbing solution storage tank 270. For example, the scrubbing solution 275 in which impurities are dissolved may be a solution in which a hydrophilic gas is dissolved in the first to third scrubbing solutions 283, 285, and 287.

In some embodiments, the hydrophilic gas may be isopropyl alcohol (IPA) and/or ammonia, although the technical scope of the present invention is not limited thereto.

The demister 260 may be disposed on the upper part of the scrubbing chamber 210. The demister 260 may be used to remove moisture from the gas after the first scrubbing process and the second scrubbing process are performed. After the first scrubbing process and the second scrubbing process are performed, the gas (G′ of FIG. 1) from which impurities have been removed may be provided. That is, moisture may be removed from the gas (G′ of FIG. 1) from which impurities have been removed after the first scrubbing process and the second scrubbing process are performed using the demister 260.

The demister 260 may be connected to the gas outlet port 26. The gas filtered through the demister 260 may be discharged to the outside of the scrubbing chamber 210 through the gas outlet port 26.

When using the scrubbing apparatus 20 according to some embodiments, gases harmful to the human body (e.g., impurities) may be dissolved in the scrubbing solution. Accordingly, gases harmful to the human body may be removed from byproducts generated after various processes are performed in various industrial fields and discharged to the outside of the scrubbing chamber 210.

In some embodiments, the first sub-space 215a may be defined by the first inner side wall 210SW1 of the scrubbing chamber 210 and the separating wall 220. For example, the first sub-space 215a may be defined by the first inner side wall 210SW1 of the scrubbing chamber 210, the third inner side wall of the scrubbing chamber 210, the fourth inner side wall of the scrubbing chamber 210, and the separating wall 220.

The first scrubbing process may be performed in the first sub-space 215a.

Specifically, the fourth scrubbing solution 281 may be supplied into the scrubbing chamber 210 through the fourth spray nozzle 221. The fourth scrubbing solution 281 may be provided to a first sub-space 215a through the fourth spray nozzle 221.

The fourth scrubbing solution 281 may be provided from the upper part to the lower part of the first sub-space 215a, and while the gas (G of FIG. 1) flows from the upper part to the lower part of the first sub-space 215a, at least a portion of the impurities contained in the gas may be dissolved in the fourth scrubbing solution 281. In some embodiments, the fourth scrubbing solution 281 may include water. However, the technical scope of the present invention is not limited thereto.

In some embodiments, the fourth spray nozzle 221 may be a spray nozzle. The fourth spray nozzle 221 may supply the fourth scrubbing solution 281 having small particles to the first sub-space 215a. Accordingly, the contact area between the fourth scrubbing solution 281 and the gas may be increased. Accordingly, the scrubbing apparatus 20 with improved scrubbing efficiency may be provided.

The fourth spray nozzle 221 may be installed on the upper part of the scrubbing chamber 210. Although not shown, the fourth spray nozzle 221 may be connected to a pipe installed outside the scrubbing chamber 210.

In some embodiments, the gas inlet port may be installed on one side of the first sub-space 215a. The gas (G of FIG. 1) introduced into the interior of the scrubbing chamber 210 may be injected into the interior of the scrubbing chamber 210 through the gas inlet port. The gas inlet port may be connected to the first pipe 11, and since the other side of the first pipe 11 is connected to the process chamber (10 of FIG. 1), the gas (G of FIG. 1) introduced into the gas inlet port may be provided from the process chamber.

In some embodiments, a negative pressure may be provided to the scrubbing space 215 through the gas inlet port and the gas outlet port 26. For example, the pressure at the gas inlet port and the pressure at the gas outlet port 26 may be different from each other. Accordingly, the gas (G of FIG. 1) may flow from the gas inlet port toward the gas outlet port 26. The first scrubbing process and the second scrubbing process may be performed by utilizing the difference between the pressure at the gas inlet port and the pressure at the gas outlet port 26.

In some embodiments, the first sub-space 215a and the second sub-space 215b may be connected to each other at the lower part of the scrubbing chamber 210. The first sub-space 215a and the second sub-space 215b may be connected to each other above the scrubbing solution storage tank 270.

That is, the gas introduced into the first sub-space 215a may flow from the upper part of the first sub-space 215a to the lower part of the first sub-space 215a and may be introduced into the second sub-space 215b from the lower part of the scrubbing chamber 210. In the second sub-space 215b, the gas (G of FIG. 1) may ascent in the second direction D2.

When using the scrubbing apparatus 20 according to some embodiments, the contact area between the scrubbing solution and the gas may be increased. Specifically, the bubbles may be formed within the scrubbing solution to increase the contact area between the scrubbing solution and the gas.

For example, in FIG. 4, the gas (G of FIG. 1) may pass through the first scrubbing hole 230H and ascend in the second direction D2 (see reference numeral 230u).

After the gas (G of FIG. 1) ascends through the first scrubbing holes 230H, the first bubbles BBL1 may be formed on the upper surface of the first scrubbing plate 230. The first bubbles BBL1 may be formed within the first scrubbing solution 283. The first bubbles BBL1 may be bubbles generated in the first scrubbing solution 283 due to a pressure of the gas attempting to ascend in the second direction D2.

At an interface where the first bubbles BBL1 and the first scrubbing solution 283 are in contact with each other, impurities contained in the gas may be dissolved in the first scrubbing solution 283. In some embodiments, the scrubbing solution provided on the upper surface of the first scrubbing plate 230 may be a mixture of the first to third scrubbing solutions 283, 285, and 287.

In some embodiments, the first scrubbing solution 283 may be provided in a spray form onto the upper surface of the first scrubbing plate 230. As the first scrubbing solution 283 is provided onto the upper surface of the first scrubbing plate 230, a height of the first bubbles BBL1 that are formed may be controlled. When the first bubbles BBL1 are formed to a height greater than a predetermined height, the discharge amount of the first scrubbing solution 283 may be increased to reduce the height of the first bubbles BBL1.

In addition, as the first scrubbing solution 283 having fine particles is provided, a contact area between the first scrubbing solution 283 and the gas is increased. Accordingly, the scrubbing apparatus 20 with improved scrubbing efficiency may be provided.

Subsequently, the gas (G of FIG. 1) may ascend in the second direction D2 by passing upward through the second scrubbing holes 240H after passing upward through the first scrubbing holes 230H (see reference numeral 240u).

After the gas (G of FIG. 1) ascends through the second scrubbing holes 240H, the second bubbles BBL2 may be formed on the upper surface of the second scrubbing plate 240. The second bubbles BBL2 may be formed within the second scrubbing solution 285. The second bubbles BBL2 may be bubbles generated in the second scrubbing solution 285 due to a pressure of the gas attempting to ascend in the second direction D2.

At an interface where the second bubbles BBL2 and the second scrubbing solution 285 are in contact with each other, impurities contained in the gas may be dissolved in the second scrubbing solution 285. In some embodiments, the scrubbing solution provided on the upper surface of the second scrubbing plate 240 may be a mixture of the second and third scrubbing solutions 285 and 287.

In some embodiments, the second scrubbing solution 285 may be provided in a spray form onto the upper surface of the second scrubbing plate 240. As the second scrubbing solution 285 is provided, a height of the second bubbles BBL2 that are formed may be controlled. When the second bubbles BBL2 are formed to a height greater than a predetermined height, the discharge amount of the second scrubbing solution 285 may be increased to reduce the height of the second bubbles BBL2.

In addition, as the second scrubbing solution 285 having fine particles is provided, a contact area between the second scrubbing solution 285 and the gas is increased. Accordingly, the scrubbing apparatus 20 with improved scrubbing efficiency may be provided.

Likewise, the gas (G of FIG. 1) may ascend in the second direction D2 by passing upward through the third scrubbing holes 250H after passing upward through the second scrubbing holes 240H (see reference numeral 250u). After the gas (G of FIG. 1) ascends through the third scrubbing holes 250H, the third bubbles BBL3 may be formed on the upper surface of the third scrubbing plate 250.

After the gas (G of FIG. 1) ascends through the third scrubbing holes 250H, the third bubbles BBL3 may be formed on the upper surface of the third scrubbing plate 250. The third bubbles BBL3 may be formed within the third scrubbing solution 287. The third bubbles BBL3 may be bubbles generated in the third scrubbing solution 287 due to a pressure of the gas attempting to ascend in the second direction D2.

At an interface where the third bubbles BBL3 and the third scrubbing solution 287 are in contact with each other, impurities contained in the gas may be dissolved in the third scrubbing solution 287.

In some embodiments, the third scrubbing solution 287 may be provided in a spray form onto the upper surface of the third scrubbing plate 250. As the third scrubbing solution 287 is provided, a height of the third bubbles BBL3 that are formed may be controlled. When the third bubbles BBL3 are excessively formed, the third bubbles BBL3 may reach the demister 260. When the third bubbles BBL3 are formed with excessive height, the height of the third bubbles BBL3 needs to be reduced.

When the third bubbles BBL3 are formed to a height greater than a predetermined height, the discharge amount of the third scrubbing solution 287 may be increased to reduce the height of the third bubbles BBL3. By controlling the height of the third bubbles BBL3, the scrubbing apparatus 20 with improved stability may be provided.

In addition, as the third scrubbing solution 287 having fine particles is provided, the contact area between the third scrubbing solution 287 and the gas is increased. Accordingly, the scrubbing apparatus 20 with improved scrubbing efficiency may be provided.

When the first to third bubbles BBL1, BBL2, and BBL3 are formed in the first to third scrubbing solutions 283, 285, and 287, the contact area between the gas and the scrubbing solutions may be increased. Accordingly, the scrubbing apparatus 20 with improved scrubbing efficiency may be provided.

In some embodiments, the first scrubbing holes 230H may have a first diameter d1. From a cross-sectional perspective, the first diameter d1 may be a width of the first scrubbing holes 230H in the first direction D1 or the third direction D3. The first scrubbing holes 230H may have a circular shape in a planar view. In this case, the first diameter d1 may be a diameter of the first scrubbing holes 230H. However, the technical scope of the present invention is not limited thereto.

Likewise, the second scrubbing holes 240H may have a second diameter d2, and the third scrubbing holes 250H may have a third diameter d3.

The sizes of the first diameter d1, the second diameter d2, and the third diameter d3 may all be the same. That is, the cross-sectional areas of the first scrubbing holes 230H, the second scrubbing holes 240H, and the third scrubbing holes 250H may be the same. In addition, the volumes of the first scrubbing holes 230H, the volumes of the second scrubbing holes 240H, and the volumes of the third scrubbing holes 250H may also be the same.

In this case, the number of the first scrubbing holes 230H is greater than the number of the second scrubbing holes 240H, and the number of the second scrubbing holes 240H is greater than the number of the third scrubbing holes 250H.

This may be because the amount of scrubbing solution provided on the second scrubbing plate 240 is greater than that provided on the third scrubbing plate 250, and the amount of scrubbing solution provided on the first scrubbing plate 230 is greater than that provided on the second scrubbing plate 240.

Specifically, only the third scrubbing solution 287 is provided on the third scrubbing plate 250, whereas both the second and third scrubbing solutions 285 and 287 are provided on the second scrubbing plate 240. The first to third scrubbing solutions 283, 285, and 287 are provided on the first scrubbing plate 230.

In this case, the gas passing through the second scrubbing holes 240H must pass through a larger amount of scrubbing solution than the gas passing through the third scrubbing holes 250H, and the gas passing through the first scrubbing holes 230H must pass through a larger amount of scrubbing solution than the gas passing through the second scrubbing holes 240H. Accordingly, the number of the first scrubbing holes 230H may be greater than the number of the second scrubbing holes 240H, and the number of the second scrubbing holes 240H may be greater than the number of the third scrubbing holes 250H.

In other words, the total area of the plurality of first scrubbing holes 230H with respect to the area of the first scrubbing plate 230 is greater than the total area of the plurality of second scrubbing holes 240H with respect to the area of the second scrubbing plate 240. In addition, the total area of the plurality of second scrubbing holes 240H with respect to the area of the second scrubbing plate 240 is greater than the total area of the plurality of third scrubbing holes 250H with respect to the area of the third scrubbing plate 250. However, the technical scope of the present invention is not limited thereto.

In some embodiments, it is also possible that the size of the second diameter d2 of each of the plurality of second scrubbing holes 240H is greater than that of the third diameter d3 of each of the plurality of third scrubbing holes 250H, and that the size of the first diameter d1 of each of the plurality of first scrubbing holes 230H is smaller than that of the second diameter d2.

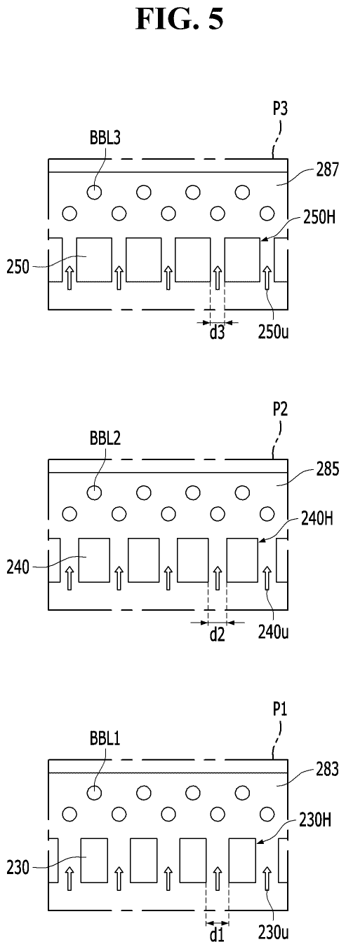

Hereinafter, the scrubbing apparatus according to some other embodiments of the present invention will be described with reference to FIGS. 5 to 10. For convenience of explanation, any content that overlaps with the content described using FIGS. 2 to 4 will be briefly described or omitted.

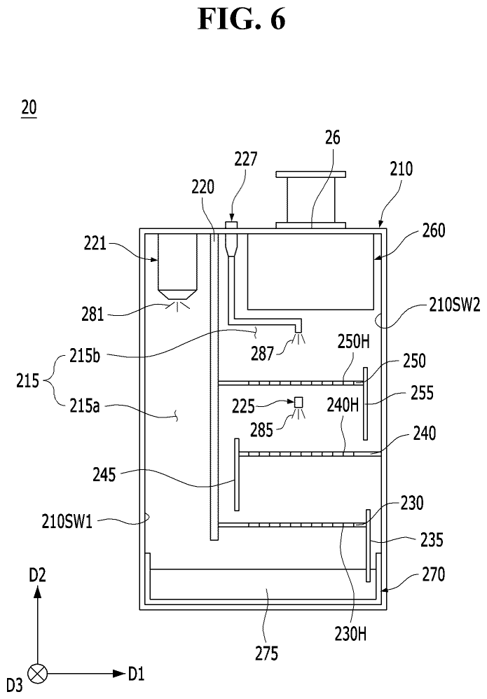

FIGS. 5 to 10 are drawings for explaining the scrubbing apparatus according to some other embodiments of the present invention, respectively. For reference, FIG. 5 may be an enlarged view of the P1 area, the P2 area, and the P3 area of FIG. 3, and FIGS. 6 to 10 may be cross-sectional views of scrubbing apparatuses according to several other embodiments of the present invention.

First, referring to FIG. 5, the sizes of the first diameter d1, the second diameter d2, and the third diameter d3 may be different from one another. For example, the size of the first diameter d1 may be greater than the size of the second diameter d2, and the size of the second diameter d2 may be greater than the size of the third diameter d3.

The cross-sectional area of each of the first scrubbing holes 230H may be greater than that of each of the second scrubbing holes 240H. The cross-sectional area of each of the second scrubbing holes 240H may be greater than that of each of the third scrubbing holes 250H. The volume of each of the first scrubbing holes 230H may be greater than that of each of the second scrubbing holes 240H. The volume of each of the second scrubbing holes 240H may be greater than that of each of the third scrubbing holes 250H.

In this case, the number of the first scrubbing holes 230H may be greater than, equal to, or less than the number of the second scrubbing holes 240H.

In addition, the total area of the plurality of first scrubbing holes 230H with respect to the area of the first scrubbing plate 230 is greater than the total area of the plurality of second scrubbing holes 240H with respect to the area of the second scrubbing plate 240, and the total area of the plurality of second scrubbing holes 240H with respect to the area of the second scrubbing plate 240 is greater than the total area of the plurality of third scrubbing holes 250H with respect to the area of the third scrubbing plate 250.

Contrary to what is illustrated, the size of the first diameter d1 may be greater than that of the second diameter d2, while the size of the second diameter d2 may be the same as that of the third diameter d3. In addition, the size of the first diameter d1 may be the same as that of the second diameter d2, while the size of the second diameter d2 may be greater than that of the third diameter d3.

Referring to FIG. 6, the scrubbing apparatus 20 according to some embodiments may not include the first spray nozzle 223. That is, the first scrubbing solution may not be provided on the upper surface of the first scrubbing plate 230. In other words, when the second scrubbing process is performed, the third scrubbing solution 287 may be provided in a spray form onto the upper surface of the third scrubbing plate 250, and the second scrubbing solution 285 may be provided in a spray form onto the upper surface of the second scrubbing plate 240. However, the first scrubbing solution is not provided in a spray form onto the upper surface of the first scrubbing plate 230. The impurities may be dissolved in the second and third scrubbing solutions 285 and 287 discharged onto the upper surface of the first scrubbing plate 230.

In FIG. 6, the scrubbing apparatus 20 is illustrated as including three scrubbing plates, but the technical scope of the present invention is not limited thereto. The scrubbing apparatus 20 may include four or more scrubbing plates.

When the scrubbing apparatus 20 includes four or more scrubbing plates, the spray nozzle may be disposed on the upper surface of the scrubbing plate located at the top, and spray nozzles may or may not be disposed on the upper surfaces of the remaining scrubbing plates. For example, the spray nozzle may be disposed on the upper surface of the scrubbing plate located at the top, no spray nozzle may be disposed on the upper surface of the scrubbing plate located at the bottom, and spray nozzles may be disposed on the upper surfaces of scrubbing plates located between the top and the bottom.

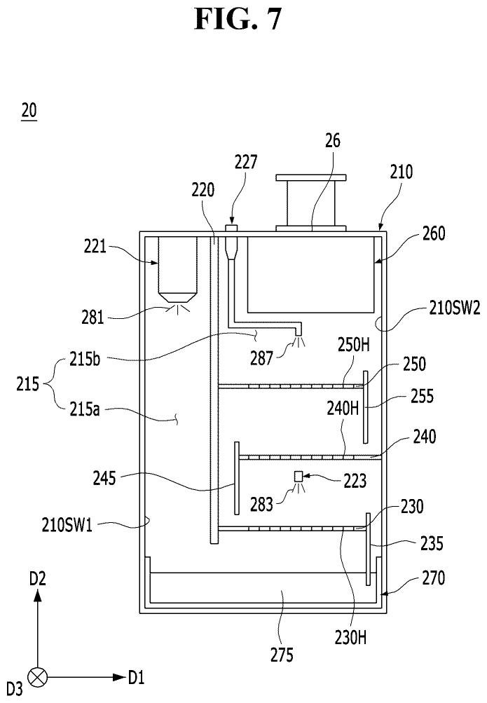

Referring to FIG. 7, the scrubbing apparatus 20 according to some embodiments may not include the second spray nozzle 225. That is, the second scrubbing solution may not be provided on the upper surface of the second scrubbing plate 240. However, the first scrubbing solution 283 is provided on the upper surface of the first scrubbing plate 230. In other words, when the second scrubbing process is performed, the third scrubbing solution 287 may be provided in a spray form onto the upper surface of the third scrubbing plate 250, and the first scrubbing solution 283 may be provided in a spray form onto the upper surface of the first scrubbing plate 230. However, the second scrubbing solution is not provided in a spray form onto the upper surface of the second scrubbing plate 240.

In FIG. 7, the scrubbing apparatus 20 is illustrated as including three scrubbing plates, but the technical scope of the present invention is not limited thereto. The scrubbing apparatus 20 may include four or more scrubbing plates.

When the scrubbing apparatus 20 includes four or more scrubbing plates, the spray nozzle may be disposed on the upper surface of the scrubbing plate located at the top, and spray nozzles may or may not be disposed on the upper surfaces of the remaining scrubbing plates. For example, the spray nozzle may be disposed on the upper surface of the scrubbing plate located at the top, another spray nozzle may be disposed on the upper surface of the scrubbing plate located at the bottom, and no spray nozzle may be disposed on the upper surfaces of the scrubbing plates located between the top and bottom.

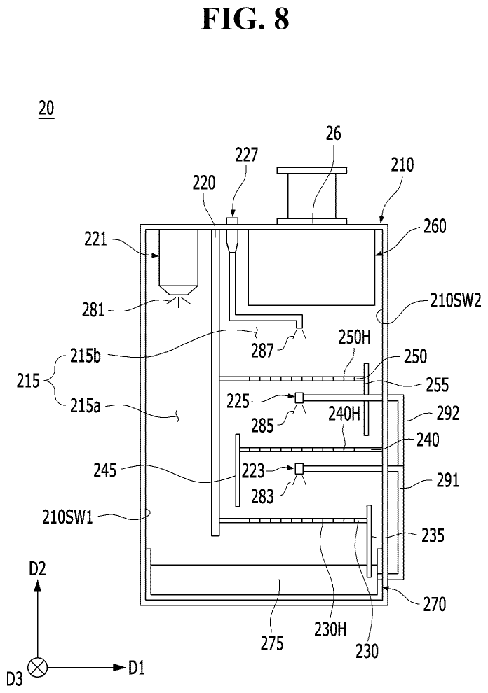

Referring to FIG. 8, the scrubbing apparatus 20 according to some embodiments may further include a first recycle pipe 291 and a second recycle pipe 292.

One end of the first recycle pipe 291 may be connected to the scrubbing solution storage tank 270, and the other end of the first recycle pipe 291 may be connected to the first spray nozzle 223. One end of the second recycle pipe 292 may be connected to the scrubbing solution storage tank 270, and the other end of the second recycle pipe 292 may be connected to the second spray nozzle 225.

In some embodiments, the first scrubbing solution 283 may be the solution 275 stored in the scrubbing solution storage tank 270. That is, in the scrubbing apparatus 20 according to some embodiments, the scrubbing solution 275 in which impurities are dissolved may be recycled and used as the first scrubbing solution 283. Similarly, the second scrubbing solution 285 may be the solution 275 stored in the scrubbing solution storage tank 270. That is, in the scrubbing apparatus 20 according to some embodiments, the scrubbing solution 275 in which impurities are dissolved may be recycled and used as the second scrubbing solution 285.

In this case, the third scrubbing solution 287 may be a fresh scrubbing solution. As the gas ascends through the scrubbing holes, the concentration of impurities contained in the gas decreases. For example, the concentration of impurities in the gas that has ascended through the second scrubbing holes 240H is lower than that in the gas that has ascended through the first scrubbing holes 230H. The concentration of impurities in the gas that has ascended through the third scrubbing holes 250H is lower than that in the gas that has ascended through the second scrubbing holes 240H.

In other words, the concentration of the impurities in the third scrubbing solution 287 may be lower than the concentration of the impurities in the second scrubbing solution 285, and the concentration of the impurities in the third scrubbing solution 287 may be lower than the concentration of the impurities in the first scrubbing solution 283. However, the technical scope of the present invention is not limited thereto.

Therefore, in order to scrub impurities contained in the gas that passes through the third scrubbing holes 250H, a scrubbing solution in which no impurities are dissolved should be used. In contrast, to scrub impurities contained in the gas that passes through the first scrubbing holes 230H and the second scrubbing holes 240H, a scrubbing solution in which some impurities are already dissolved may be used.

That is, according to some embodiments, whether to recycle the scrubbing solution 275 in which impurities are dissolved may be determined based on the concentration of impurities contained in the gas and the number of scrubbing plates included in the scrubbing apparatus 20.

In some embodiments, the first scrubbing solution 283 may be the solution 275 stored in the scrubbing solution storage tank 270, and the second scrubbing solution 285 may be a fresh scrubbing solution. Conversely, the first scrubbing solution 283 may be a fresh scrubbing solution, and the second scrubbing solution 285 may be the solution 275 stored in the scrubbing solution storage tank 270.

The scrubbing apparatus 20 according to some embodiments may recycle previously used scrubbing solutions. Accordingly, the amount of fresh scrubbing solution used may be reduced.

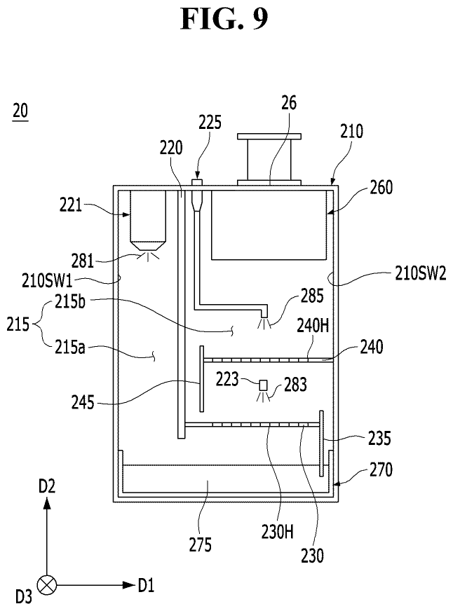

Referring to FIG. 9, the scrubbing apparatus according to some embodiments may include only the first scrubbing plate 230 and the second scrubbing plate 240. That is, the scrubbing apparatus 20 may include the first scrubbing plate 230 and the second scrubbing plate 240.

The second scrubbing plate 240 may be disposed on the first scrubbing plate 230. Specifically, the second scrubbing plate 240 may be positioned on the upper surface of the first scrubbing plate 230, and the first scrubbing plate 230 may be positioned on the lower surface of the second scrubbing plate 240. No other scrubbing plate may be disposed on the upper surface of the second scrubbing plate 240.

In some embodiments, the second scrubbing solution 285 may be supplied from the second spray nozzle 225 and discharged onto the upper surface of the second scrubbing plate 240. Specifically, the second scrubbing solution 285 may be discharged to the central area of the upper surface of the second scrubbing plate 240.

The discharged second scrubbing solution 285 may flow toward the second scrubbing wall 245 along the upper surface of the second scrubbing plate 240 while the second scrubbing process is being performed. The second scrubbing solution 285 may flow downward beyond the second scrubbing wall 245. In this case, the second scrubbing solution 285 does not flow downward through the second scrubbing holes 240H. The second scrubbing solution 285 that flows downward beyond the second scrubbing wall 245 may be discharged onto the upper surface of the first scrubbing plate 230.

The first scrubbing solution 283 may be supplied from the first spray nozzle 223 and discharged onto the upper surface of the first scrubbing plate 230. Specifically, the first scrubbing solution 283 may be discharged to the central area of the upper surface of the first scrubbing plate 230.

Likewise, the first scrubbing solution 283 may flow toward the first scrubbing wall 235 along the upper surface of the first scrubbing plate 230 while the second scrubbing process is being performed. In this case, the first scrubbing solution 283 does not flow downward through the first scrubbing holes 230H. The first scrubbing solution 283 may flow downward beyond the first scrubbing wall 235 into the lower part of the scrubbing chamber 210.

Although not illustrated, the first scrubbing solution 283 may be a previously used scrubbing solution 275 in which impurities are dissolved, and the second scrubbing solution 285 may be a fresh scrubbing solution.

The scrubbing apparatus 20 shown in FIG. 9 includes only two scrubbing plates 230 and 240. Accordingly, the height of the scrubbing apparatus 20 in the second direction D2 may be reduced. That is, when the scrubbing apparatus 20 according to some embodiments of the present invention is used, spatial efficiency may be improved.

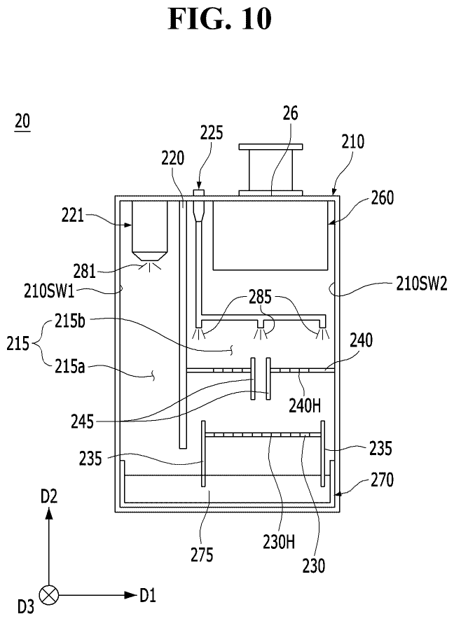

Referring to FIG. 10, in the scrubbing apparatus 20 according to some embodiments, the shape of the first scrubbing plate 230 may differ from the shape of the second scrubbing plate 240.

For example, both ends of the first scrubbing plate 230 may be spaced apart from the separating wall 220 and the second inner side wall 210SW2. Specifically, the both ends of the first scrubbing plate 230 may not be in contact with and not connected to both the separating wall 220 and the second inner side wall 210SW2 of the first scrubbing plate 230. Although not illustrated, the first scrubbing plate 230 may be connected in contact with the third inner side wall and the fourth inner side wall.

A pair of first scrubbing walls 235 may be disposed at both ends of the first scrubbing plate 230. Some of the first scrubbing walls 235 may be interposed between the first scrubbing plate 230 and the separating wall 220, and the others may be interposed between the first scrubbing plate 230 and the second inner side wall 210SW2.

The space between the first scrubbing wall 235 and the separating wall 220, and the space between the first scrubbing wall 235 and the second inner side wall 210SW2 may each be a space in which the second scrubbing solution 285 flows downward (e.g., in the second direction D2).

Both ends of the second scrubbing plate 240 may be connected in contact with the separating wall 220 and the second inner side wall 210SW2, respectively. The second scrubbing plate 240 may have a structure with an opening in its central portion. That is, the second scrubbing plate 240 may include an opening formed in its central portion and extending in the third direction D3. The opening may expose at least a portion of the upper surface of the first scrubbing plate 230. That is, the opening may overlap at least a portion of the upper surface of the first scrubbing plate 230 in the second direction D2.

A pair of second scrubbing walls 245 may be disposed in the central portion of the second scrubbing plate 240. Each of the pair of second scrubbing walls 245 may be disposed within the opening.

The pair of second scrubbing walls 245 may be spaced apart from each other in the first direction D1. The space between the pair of second scrubbing walls 245 may serve as a flow path for the second scrubbing solution 285 to flow downward (e.g., in the second direction D2). That is, the second scrubbing solution 285 may flow downward through the opening.

In some embodiments, the second scrubbing solution 285 may be discharged onto both ends and the central portion of the second scrubbing plate 240. Since the second scrubbing plate 240 has a structure with an opening in its center, the second scrubbing solution 285 discharged onto the central portion may be directly discharged onto the upper surface of the first scrubbing plate 230.

The second scrubbing solution 285 may be discharged to an area of the second scrubbing plate 240 adjacent to the separating wall 220 and to another area adjacent to the second inner side wall 210SW2.

The second scrubbing solution 285 discharged onto the upper surface of the second scrubbing plate 240 may flow toward the central portion of the second scrubbing plate 240. The second scrubbing solution 285 discharged onto the upper surface of the second scrubbing plate 240 may flow into the opening. While flowing toward the central portion of the second scrubbing plate 240, impurities may dissolve in the second scrubbing solution 285. The second scrubbing solution 285 may overflow the second scrubbing wall 245 and be discharged onto the upper surface of the first scrubbing plate 230. The second scrubbing solution 285 discharged onto the upper surface of the first scrubbing plate 230 may flow toward both ends of the first scrubbing plate 230.

In FIG. 10, the scrubbing apparatus 20 is illustrated as including two scrubbing plates, but the technical scope of the present invention is not limited thereto. If the scrubbing apparatus 20 includes three scrubbing plates, the shape of the third scrubbing plate may be the same as that of the first scrubbing plate 230. The third scrubbing plate may be disposed on the second scrubbing plate 240.

If the scrubbing apparatus 20 includes four scrubbing plates, the shape of the third scrubbing plate may be the same as that of the first scrubbing plate 230, and the shape of the fourth scrubbing plate may be the same as that of the second scrubbing plate 240. The third scrubbing plate may be disposed on the second scrubbing plate 240, and the fourth scrubbing plate may be disposed on the third scrubbing plate.

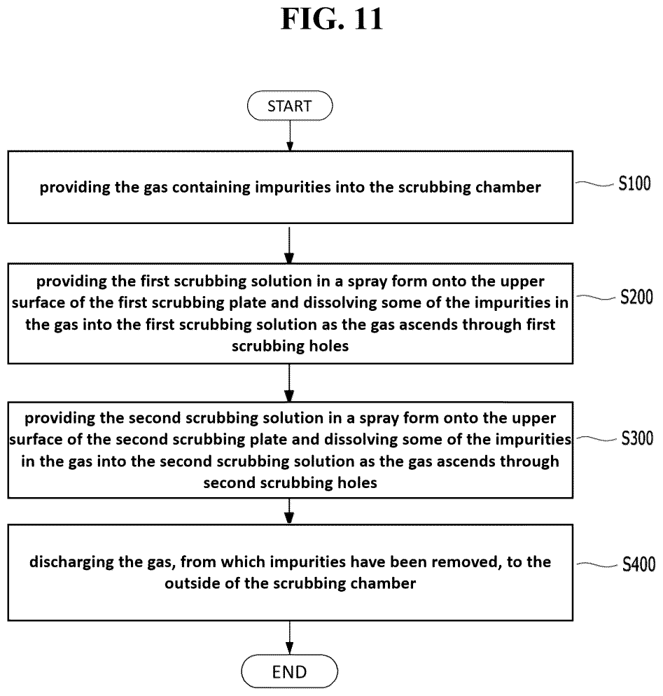

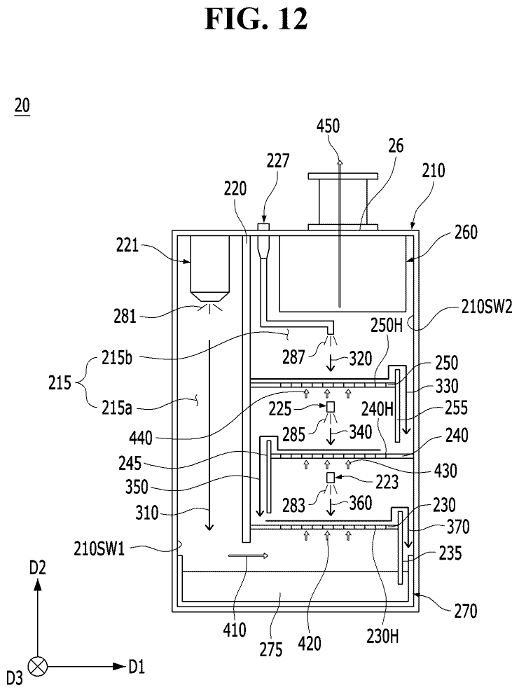

Hereinafter, an operating method of the scrubbing apparatus according to some embodiments of the present invention will be described with reference to FIGS. 11 and 12. For reference, FIG. 11 may be an exemplary flowchart for explaining an operating method of the scrubbing apparatus according to some embodiments of the present invention.

FIGS. 11 and 12 are drawings for explaining an operating method of a scrubbing apparatus according to some embodiments of the present invention.

First, referring to FIG. 11, the operating method of the scrubbing apparatus according to some embodiments of the present invention may include providing the gas containing impurities into the scrubbing chamber S100, providing the first scrubbing solution in a spray form onto the upper surface of the first scrubbing plate and dissolving some of the impurities in the gas into the first scrubbing solution as the gas ascends through first scrubbing holes S200, providing the second scrubbing solution in a spray form onto the upper surface of the second scrubbing plate and dissolving some of the impurities in the gas into the second scrubbing solution as the gas ascends through second scrubbing holes S300, and discharging the gas, from which impurities have been removed, to the outside of the scrubbing chamber S400. The concentration of impurities in the gas discharged to the outside of the scrubbing chamber may be very low.

Specifically, referring to FIG. 1 and FIG. 12, the gas G containing impurities may be provided from the process chamber 10 to the scrubbing apparatus 20. The gas G containing impurities may pass through a first pipe 11 and be introduced into the interior of the scrubbing apparatus 20 through the gas inlet 25. The gas G containing impurities may be introduced into the first sub-space 215a. For example, the gas G containing impurities may move to the lower part of the first sub-space 215a.

In some embodiments, the first scrubbing process may be performed in the first sub-space 215a.

Specifically, the fourth scrubbing solution 281 may be supplied into the first sub-space 215a through the fourth spray nozzle 221 (see reference numeral 310). The fourth scrubbing solution 281 may be water, however, the technical scope of the present invention is not limited thereto.

In FIG. 12, the fourth scrubbing solution 281 is illustrated as being sprayed vertically in the second direction D2, however, the technical scope of the present invention is not limited thereto.

The fourth spray nozzle 221 may supply the fourth scrubbing solution 281 having fine particles. As gas G containing impurities moves into the lower part of the first sub-space 215a, impurities contained in the gas G may be dissolved into the fourth scrubbing solution 281. The first scrubbing process may be a process in which impurities contained in the gas G are dissolved into the fourth scrubbing solution 281.

The gas G, from which some impurities have been removed, may be supplied to the second sub-space 215b (see reference numeral 410). In the second sub-space 215b, the second scrubbing process may be performed. The second scrubbing process may be a process in which impurities contained in the gas G are dissolved into the first to third scrubbing solution 283, 285, and 287.

During the second scrubbing process, the third spray nozzle 227 may supply the third scrubbing solution 287 onto the upper surface of the third scrubbing plate 250 (see reference numeral 320). The third scrubbing solution 287 may be supplied in a spray form. The third scrubbing solution 287 may be provided to the central portion of the third scrubbing plate 250.

Initially supplied third scrubbing solution 287 may flow downward through the third scrubbing holes 250H, the second scrubbing holes 240H, and the first scrubbing holes 230H. That is, in the initial state, the third scrubbing solution 287 may flow downward through the scrubbing holes 250H, 240H, and 230H.

During the second scrubbing process, the gas G may ascend in the second direction D2. The gas G may ascend in the second direction D2 while passing through the first scrubbing holes 230H (see reference numeral 420), may ascend in the second direction D2 while passing through the second scrubbing holes 240H (see reference numeral 430), and may ascend in the second direction D2 while passing through the third scrubbing holes 250H (see reference numeral 440).

Specifically, referring to FIG. 4, the gas G may ascend through the first to third scrubbing holes 230H, 240H, and 250H. As the gas G ascends in the second direction D2, first to third bubbles BBL1, BBL2, and BBL3 may be formed within the first to third scrubbing solutions 283, 285, and 287. The impurities contained in the gas G may be dissolved into the first to third scrubbing solutions 283, 285, and 287 at the contact area between the first to third bubbles BBL1, BBL2, and BBL3 and the first to third scrubbing solutions 283, 285, and 287.

During the second scrubbing process, the third scrubbing solution 287 does not flow downward through the third scrubbing hole 250H. This may be due to the pressure of the gas G ascending through the third scrubbing hole 250H. As the gas ascends through the third scrubbing hole 250H, the third bubble BBL3 may be formed on the upper surface of the third scrubbing plate 250. The third bubble BBL3 is formed within the third scrubbing solution 287. The height of the third bubble BBL3 may be controlled by adjusting the discharge amount of the third scrubbing solution 287.

During the second scrubbing process, the third scrubbing solution 287 may flow on the upper surface of the third scrubbing plate 250 toward the third scrubbing wall 255, pass over the third scrubbing wall 255, and flow onto the upper surface of the second scrubbing plate 240 (see reference numeral 330).

Subsequently, during the second scrubbing process, the second spray nozzle 225 may supply the second scrubbing solution 285 onto the upper surface of the second scrubbing plate 240 (see reference numeral 340). The second scrubbing solution 285 may be supplied in a spray form. The second scrubbing solution 285 may be provided at the central portion of the second scrubbing plate 240.

As the gas passes upward through the second scrubbing hole 240H, the second bubble BBL2 may be formed on the upper surface of the second scrubbing plate 240. The second bubble BBL2 is formed in the second scrubbing solution 285 or the third scrubbing solution 287. The height of the second bubble BBL2 may be controlled by adjusting the discharge amount of the second scrubbing solution 285.

The second scrubbing solution 285 may flow on the upper surface of the second scrubbing plate 240 toward the second scrubbing wall 245 and pass over the second scrubbing wall 245 to flow onto the upper surface of the first scrubbing plate 230 (see reference numeral 350).

Subsequently, during the second scrubbing process, the first spray nozzle 223 may supply the first scrubbing solution 283 onto the upper surface of the first scrubbing plate 230 (see reference numeral 360). The first scrubbing solution 283 may be provided to the central portion of the upper surface of the first scrubbing plate 230.

As the gas passes upward through the first scrubbing hole 230H, the first bubble BBL1 may be formed on the upper surface of the first scrubbing plate 230. The first bubble BBL1 may be formed in the first scrubbing solution 283, the second scrubbing solution 285, or the third scrubbing solution 287. The height of the first bubble BBL1 may be controlled by adjusting the discharge amount of the first scrubbing solution 283.

The first scrubbing solution 283 may flow on the upper surface of the first scrubbing plate 230 toward the first scrubbing wall 235, and may flow beyond the first scrubbing wall 235 to the lower part of the scrubbing chamber 210 (see reference numeral 370).

The impurities may be dissolved in the first to fourth scrubbing solutions 283, 285, 287, and 281 and stored in the scrubbing solution storage tank 270.

As the gas G passes upward through the scrubbing holes 250H, 240H, and 230H, the impurities may be dissolved into the first to third scrubbing solutions 283, 285, and 287.

Subsequently, the gas G′ from which the impurities have been removed may pass through the demister 260 and be discharged to the outside of the scrubbing chamber 210 (see reference numeral 450). The gas G′ discharged through the gas outlet 26 may contain little to no remaining impurities.

As such, by using the scrubbing apparatus 20 of the present invention, the contact area between the gas and the scrubbing solution may be increased, thereby improving scrubbing efficiency. In addition, the stability may be enhanced by controlling the height of the bubbles formed on the upper surface of the scrubbing plate.

Although the embodiments of the present invention have been described with reference to the attached drawings, the present invention is not limited to the embodiments described above, but can be manufactured in various different forms, and a person having ordinary skill in the art to which the present invention pertains will understand that the present invention can be implemented in other specific forms without changing the technical scope or essential features of the present invention. Therefore, it should be understood that the embodiments described above are exemplary in all respects and not restrictive.

1. A scrubbing apparatus comprising:
a scrubbing chamber defining a scrubbing space for scrubbing impurities contained in a gas;
a first scrubbing plate disposed in the scrubbing chamber;
a plurality of first scrubbing holes penetrating the first scrubbing plate;
a second scrubbing plate on the first scrubbing plate, and disposed in the scrubbing chamber;
a plurality of second scrubbing holes penetrating the second scrubbing plate;
a first spray nozzle supplying a first scrubbing solution onto an upper surface of the first scrubbing plate, wherein the first spray nozzle is disposed between the first scrubbing plate and the second scrubbing plate; and
a second spray nozzle supplying a second scrubbing solution onto an upper surface of the second scrubbing plate, wherein the second spray nozzle is disposed on the second scrubbing plate,
wherein a portion of impurities contained in the gas is dissolved in the first scrubbing solution by ascending through the plurality of first scrubbing holes, and
wherein another portion of the impurities contained in the gas is dissolved in the second scrubbing solution by ascending through the plurality of second scrubbing holes.

2. The scrubbing apparatus of claim 1, wherein a diameter of each of the plurality of first scrubbing holes is greater than a diameter of each of the plurality of second scrubbing holes.

3. The scrubbing apparatus of claim 1, wherein, in a planar view, an area of the plurality of first scrubbing holes relative to an area of the first scrubbing plate is greater than an area of the plurality of second scrubbing holes relative to an area of the second scrubbing plate.

4. The scrubbing apparatus of claim 3, wherein a diameter of each of the plurality of first scrubbing holes is equal to a diameter of each of the plurality of second scrubbing holes.

5. The scrubbing apparatus of claim 1, wherein the number of the plurality of first scrubbing holes is greater than the number of the plurality of second scrubbing holes.

6. The scrubbing apparatus of claim 1, further comprising:
a scrubbing solution storage tank disposed at a lower part of the scrubbing chamber, the scrubbing solution storage tank storing a scrubbing solution in which the impurities are dissolved; and
a first recycle pipe having one end connected to the scrubbing solution storage tank and the other end connected to the first spray nozzle,
wherein the first spray nozzle supplies the scrubbing solution, in which the impurities are dissolved, and which is stored in the scrubbing solution storage tank, onto the upper surface of the first scrubbing plate through the first recycle pipe.

7. The scrubbing apparatus of claim 6, wherein the second scrubbing solution is water that does not contain the impurities.

8. The scrubbing apparatus of claim 6, further comprising:
a second recycle pipe having one end connected to the scrubbing solution storage tank and the other end connected to the second spray nozzle,
wherein the second spray nozzle supplies the scrubbing solution, in which the impurities are dissolved, and which is stored in the scrubbing solution storage tank, onto the upper surface of the second scrubbing plate through the second recycle pipe.

9. The scrubbing apparatus of claim 1, further comprising:
a third scrubbing plate disposed on the second scrubbing plate, and disposed in the scrubbing chamber;
a plurality of third scrubbing holes penetrating the third scrubbing plate; and
a third spray nozzle supplying a third scrubbing solution onto an upper surface of the third scrubbing plate, wherein the third spray nozzle is disposed on the third scrubbing plate,
wherein the third spray nozzle supplies the third scrubbing solution in a spray form, and
wherein another portion of the impurities contained in the gas is dissolved in the third scrubbing solution by ascending through the plurality of third scrubbing holes.

10. The scrubbing apparatus of claim 9, wherein a diameter of each of the plurality of second scrubbing holes is greater than a diameter of each of the plurality of third scrubbing holes, and
wherein a diameter of each of the plurality of first scrubbing holes is greater than the diameter of each of the plurality of second scrubbing holes.

11. The scrubbing apparatus of claim 9, wherein a diameter of each of the plurality of second scrubbing holes is greater than a diameter of each of the plurality of third scrubbing holes, and
wherein a diameter of each of the plurality of first scrubbing holes is smaller than the diameter of each of the plurality of second scrubbing holes.

12. The scrubbing apparatus of claim 9, wherein a concentration of the impurities in the third scrubbing solution is lower than a concentration of the impurities in the second scrubbing solution.

13. The scrubbing apparatus of claim 12, wherein the first scrubbing solution is the same as the second scrubbing solution.

14. The scrubbing apparatus of claim 1, further comprising:
a second scrubbing wall disposed at one end of the second scrubbing plate and partially protruding from an upper surface of the second scrubbing plate,
wherein the second scrubbing solution discharged onto the upper surface of the second scrubbing plate flows over the second scrubbing wall and is discharged onto the upper surface of the first scrubbing plate, and
wherein another portion of the impurities contained in the gas is dissolved in the second scrubbing solution that has flowed over the second scrubbing wall by ascending through the first scrubbing holes.

15. The scrubbing apparatus of claim 1, wherein the first spray nozzle supplies the first scrubbing solution in a spray form onto the upper surface of the first scrubbing plate, and
wherein the second spray nozzle supplies the second scrubbing solution in a spray form onto the upper surface of the second scrubbing plate.
